(19) United States
(12) Patent Application Publication
(10) Pub. No.: US 2018/0236936 A1
(43) Pub. Date: Aug. 23, 2018

(54) Method for Enhancing the Safety of a Mobile Occupant Carrier In a Motor Vehicle

(71) Applicant: E-Z Lock, Inc., Baton Rouge, LA (US)

(72) Inventor: Jack Cali, Montz, LA (US)

(73) Assignee: E-Z Lock, Inc., Baton Rouge, LA (US)

(21) Appl. No.: 15/900,916

(22) Filed: Feb. 21, 2018

Related U.S. Application Data
(60) Provisional application No. 62/461,797, filed on Feb. 22, 2017.

(51) Int. Cl. B60Q 5/00; B60K 28/08; F02P 11/04

(52) U.S. Cl. CPC B60Q 5/005; B60K 2028/003; F02P 11/04; B60K 28/08

(57) ABSTRACT

A system is disclosed to provide voice messages to alert users when a mobile occupant carrier such as a wheelchair is improperly secured in a motor vehicle, and to provide instructions to correct potentially dangerous situations. The system substantially improves user compliance with proper procedures, and significantly enhances safety.

The benefit of the Feb. 22, 2017 filing date of U.S. provisional patent application Ser. No. 62/461,797 is claimed under 35 U.S.C. § 119(e). The complete disclosure of the priority application is hereby incorporated by reference in its entirety.

### TECHNICAL FIELD

This invention pertains to method for enhancing the safety of a mobile occupant carrier, such as an occupied wheelchair or other small-sized wheeled carrier, within a motor vehicle.

### BACKGROUND ART

There is a continuing need for improved methods to further the safety of occupants of mobile occupant carriers, while those carriers are being transported in motor vehicles. Various mobile occupant carrying devices are known in the art for enhancing the mobility of physically disabled people, for example wheelchairs, three-wheeled scooters, power base wheelchairs, and the like. There are many instances when such a device, for safety or other reasons, should be secured to a surrounding structure, for example, when the occupant boards a vehicle such as a van, bus, or train. Safety laws usually require that the vehicle be equipped with a device for securing the mobile occupant carrier within the vehicle. The problem for designers of mobile occupant carrier systems is to design occupant carrying devices that have superior securing capability, and that at the same time are easy and quick to operate by either the occupant of the mobile occupant carrier, or by the vehicle's driver or another person.

U.S. Pat. Nos. 6,685,403 and 6,474,916 describe a mobile occupant carrier restraint system that is resistant to both front and side impacts, that reduces or eliminates the need for assistance when docking, and that restrains the carrier quickly and securely into a transport vehicle, e.g., the bed of a truck or trailer.

U.S. Pat. Nos. 4,389,537 and 6,198,388 describe voice warning systems for automobiles, to notify a car's driver of the conditions of the car.

Previous restraint systems have used buzzers or beeps to warn users when a wheelchair (or other carrier) is not properly secured, or otherwise to indicate that the system has malfunctioned. Different buzzes, tones, or combinations have been used to alert users to different states of the system, some of which can indicate that it is currently unsafe to operate the system in a moving vehicle. However, users can sometimes find it difficult to understand or remember the meaning of the various buzzes and tones, especially given the multitude of sounds that modern automobiles and other devices currently emit. Users sometimes seem not to hear the buzzes and beeps at all. Users have even been known to ignore or disable what is perceived as an “annoying buzzer” rather than service the equipment properly. If the system is deactivated, the wheelchair user may not be safe until the system is properly repaired. Unfortunately, serious injury and even death have occurred when these warning sounds have been disregarded and an accident ensued, and because the warning was disregarded a wheelchair was improperly restrained at the time of the accident.

Wheelchair restraint systems for use in motor vehicles have been commercially available for ˜30 years. Despite this long period of use, there remains an unfilled need for an improved method to encourage proper use of the restraint systems. Despite the occurrence of occasional unfortunate and even serious accidents, to the inventor's knowledge there have been no previous methods for improving user compliance with the proper use of the restraint system, and for correcting potentially dangerous conditions before an accident occurs. Existing warning systems can be ignored or misunderstood.

### SUMMARY OF THE INVENTION

I have discovered an improved system to alert users to improperly secured mobile occupant carriers in motor vehicles, and for correcting potentially dangerous situations. The notification system provides specific, easily-understood voice messages to notify users of improperly secured carriers, or other potentially dangerous situations. Implementation of voice-based notifications dramatically improves users' understanding of the meaning of warning messages, substantially improves compliance with proper procedures, and significantly enhances safety. The system determines the state of the mobile occupant carrier docking system and the state of the vehicle ignition, and provides verbal messages to users as appropriate, in real-time.

The novel voice notification system increases compliance with the correct use of vehicle restraint systems for mobile occupant carriers such as wheelchairs. Increased compliance should result in fewer injuries and saved lives. Users need no longer try to remember the meaning of various buzzing tones—possibly long after the original installation of a system, and after memory has faded. Warning messages are more likely to be heard and heeded. An additional benefit of voice notification is that people who struggle to discern between different tones (e.g. those who are tone deaf) can use a system that provides clear verbal warnings.

### BRIEF DESCRIPTION OF THE DRAWINGS

FIG. 1 depicts a schematic design of a wheelchair docking system with voice notification circuit and speaker.

FIG. 2 depicts a flowchart for two possible messages when the ignition of a vehicle is turned on.

FIG. 3 depicts a flowchart for two possible messages when the restraint system is activated or deactivated.

FIG. 4 depicts a flowchart for a message played when the restraint system malfunctions.

FIG. 5 depicts a flowchart for messages played when the release button is pressed and the latching mechanism state is checked.

FIG. 6 depicts a perspective view of one embodiment of a restraint device for a mobile occupant carrier.

FIG. 7 depicts a perspective view of one embodiment of universal adapters attached to the frame of a wheelchair.

FIG. 8 depicts a perspective view of one embodiment of a restraint device, showing a bracket assembly connected to universal adapters and locked in the docking station.

FIGS. 9A through 9G depict circuit elements used in one embodiment of the invention.

FIGS. 10A through 10C depict circuit elements used in one embodiment of the invention.

FIG. 11 depicts circuit elements used in one embodiment of the invention.

FIG. 12 depicts circuit elements used in one embodiment of the invention.

### MODES FOR CARRYING OUT THE INVENTION

### Voice-Based Notification System

One embodiment of the novel system is implemented with sensors, software, and speakers that can be incorporated into new restraint systems, as well as being retrofitted onto existed systems. Verbal messages alert users about the state of the restraint system, using inputs from sources such as the restraint system's electronic control unit, the vehicle ignition, the restraint release, and its locking mechanism. The novel voice notification system enhances safety, both for the occupant of the mobile occupant carrier and for other passengers in the vehicle.

Voice-based notifications alert users when certain states are detected. For example: The notification circuit detects the state of the locking mechanism, whether it is locked or unlocked. The circuit detects whether the universal restraint system is activated or deactivated. It detects the voltage of a solenoid connection to determine whether there is a solenoid malfunction. It detects the state of the vehicle ignition: on, off, or transitioning from off to on.

One embodiment uses an mp3 semiconductor chip to play one or more message sound files on a speaker. The voice notification circuit notifies users when a problem is detected—using a recording of spoken words—and the circuit also advises what corrective action should be taken—again, in spoken words. For example, the ignition should not be turned on before the wheelchair is locked into the base. User understanding and compliance is greatly enhanced, as compared to prior systems using buzzers and beeps, and as a result safety is significantly improved.

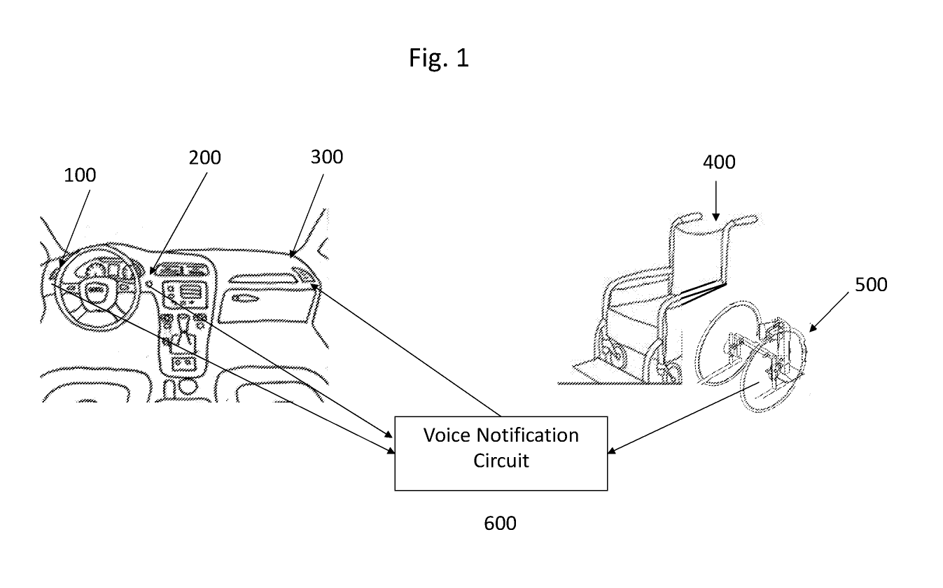

FIG. 1 depicts schematically a wheelchair docking system with a voice notification circuit and a speaker. Voice notification circuit 600 includes an mp3 chip and firmware. In a prototype embodiment, the voice notification circuit 600 was implemented on an ATMEGA32U2AU microchip. Voice notification circuit 600 receives a signal from ignition sensor 200 to detect whether the ignition is on, off, or transitioning. Voice notification circuit 600 checks the state of latching mechanism 500, to determine the appropriate sound message to play from the mp3 chip on audio speaker(s) 300. Pressing remote release button 100 triggers the voice notification circuit to check the state of ignition 200 before opening the latching mechanism 500 to allow the wheelchair 400 to exit the vehicle. Voice notification circuit 600 monitors the universal restraint system's activation state, the latching mechanism's solenoid state, and the system status to determine when to play sound files from the mp3 chip on the audio speaker(s) 300 to alert users to a specific problem.

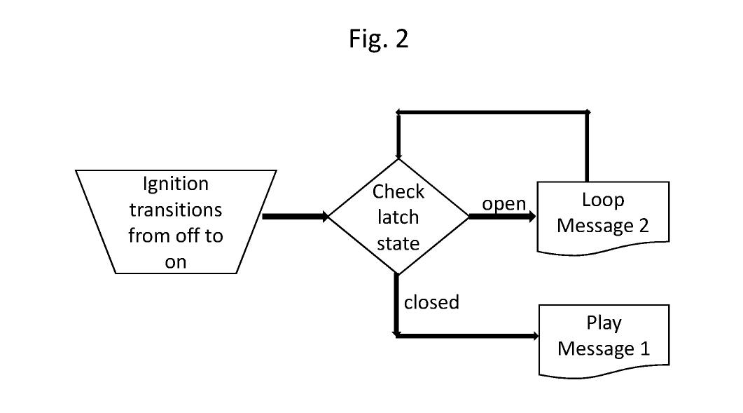

FIG. 2 depicts a flowchart for actions that follow turning on the ignition. When the voice notification circuit detects that the ignition has been turned on, the circuit polls the state of the latching mechanism. If the latching mechanism is closed, meaning that the wheelchair is locked in place, message 1 is played: “Ready . . . Chair locked.” If the latching mechanism is open, meaning that the wheelchair is not locked, message 2 plays: “Stop . . . Chair not locked.” Message 2 is looped until the wheelchair is locked in place. Message 2 (and the other voice messages) are intended to be sufficiently loud and clear (and sufficiently annoying) that most users will be unable to ignore them, or to misunderstand them. Where applicable, the messages are looped until the untoward condition has been resolved, making them especially difficult for human users to ignore them.

Preferably the latch remains open whenever there is no wheelchair in the vehicle, so the latch is always ready to receive a chair. When no wheelchair is present in the vehicle, the system will indicate that the chair is not locked; however, there is a manual “deactivate” option that allows the user to choose to bypass the warnings. Following any deactivation, however, as soon as the ignition is toggled the system will once again revert to its normal mode, for example warning the user that the chair is not locked. The bypass feature provides a “one-time” deactivation, and it must be manually chosen each time when applicable. The user is required to hold the release button for 3 to 5 seconds to bypass the warnings; more is required than just a casual swipe. As soon as any change is detected for the ignition status, each time the system reverts to its normal working mode.

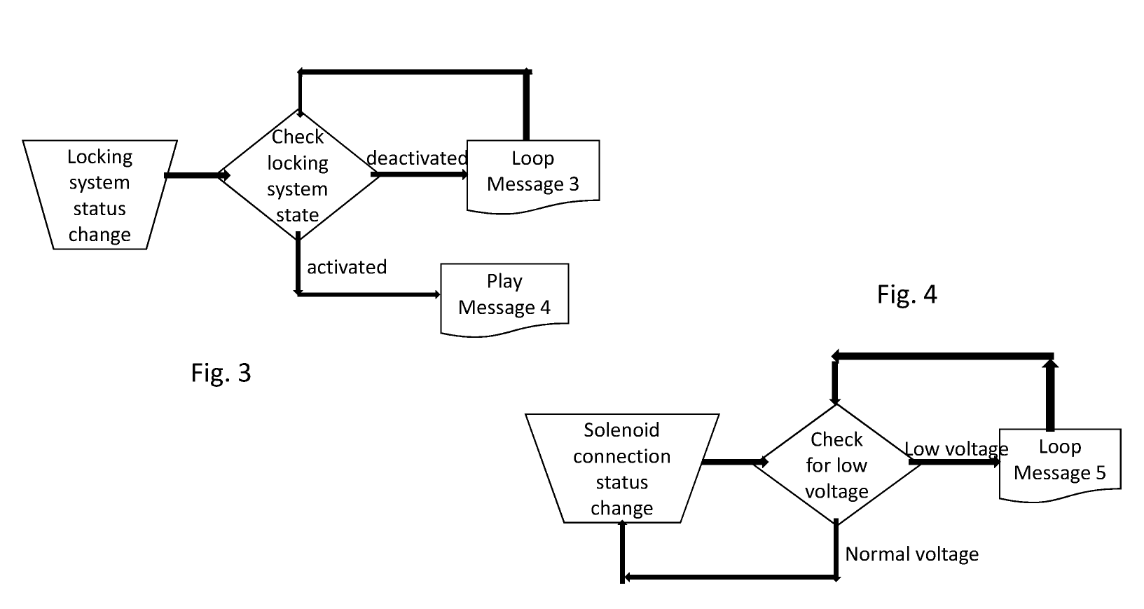

FIG. 3 depicts a flowchart for the action of deactivating or activating the universal restraint system. When the voice notification circuit detects that the universal restraint system has been disabled, message 3 plays: “Warning . . . Lock deactivated.” Message 3 is looped until the system is reactivated. The circuit continues to poll the locking system until it is activated, at which time message 4 is played: “Lock reactivated.”

FIG. 4 depicts a flowchart for a change in the solenoid status. When the voice notification circuit detects an anomalous solenoid voltage, message 5 is played: “Solenoid malfunction . . . Service required.” The circuit continues to monitor the solenoid voltage and to alert the user of the problem by playing message 5. The voice notification circuit controls a relay that causes a solenoid to “pull back” (or open) the latching mechanism, which releases the chair. The latching mechanism automatically retracts (or closes) by a spring attached to the solenoid. When the voice notification circuit detects an anomalous voltage, message 5 is played: “Solenoid malfunction . . . Service required.” Solenoids can fail electrically or mechanically. If a solenoid fails mechanically—e.g., sticking in an “open” position, then that failure would be monitored via the latching mechanism switches, indicating whether the latch is open or closed. If a solenoid fails electrically, then that failure would be monitored via the behavior of the solenoid circuit itself. If the solenoid indicates a voltage outside the expected range, indicating an anomalous resistance or other electrical failure, then message 5 is played.

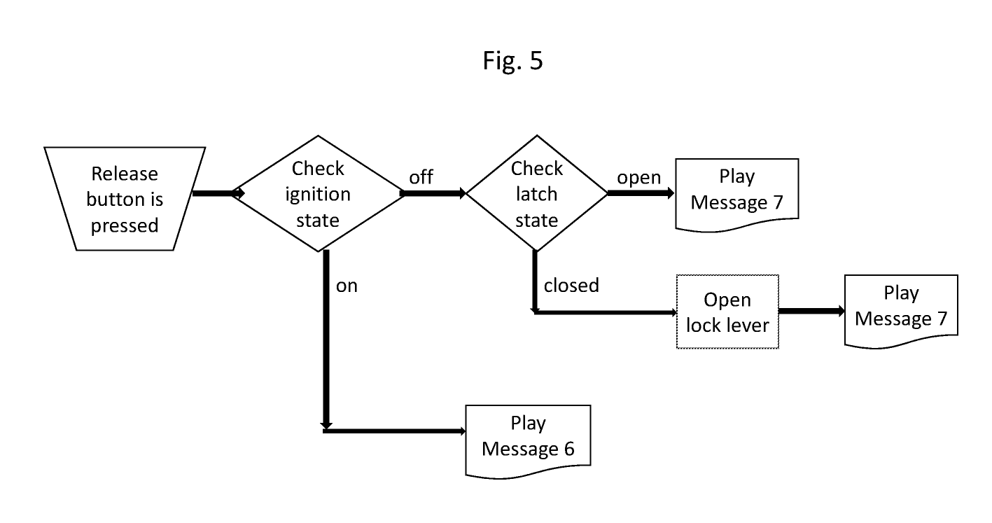

FIG. 5 depicts a flowchart for the action of pressing a remote release button to unlock the wheelchair. When the release button is pressed, the ignition state is checked and if the ignition is on, message 6 is played: “Please turn off ignition to unlock chair.” If the ignition is off, the latching mechanism state is checked. If the latch is closed, the lock lever is opened and message 7 is played: “Chair unlocked . . . Please roll back.” If the mechanism is unlocked manually, message 7 is also played.

The voice notification circuit works with most existing wheelchair docking systems' electronic control units. In the prototype device there were electrical connections added to the solenoid, to the lever switch in the locking mechanism, to custom firmware, to an mp3 chip, and to an external speaker.

The speaker may be a special-purpose speaker, or an existing speaker in the vehicle. Connection to the speaker may be wired or wireless (e.g. Bluetooth). However, wired connections are preferred as providing greater reliability, a particularly important consideration where safety is an issue.

### System State and Messages

Following are non-limiting examples of the types of messages that can be played by the voice notification circuit in response to various vehicle and wheelchair states:

When the ignition transitions from off to on and the latching mechanism is closed (locked), meaning the wheelchair is secure, play message: “Ready <optional 1 sec pause> Chair locked.”

When the ignition transitions from off to on and the latching mechanism is open (unlocked), meaning the wheelchair is not secure, loop message: “Stop <optional 1 sec pause> Chair not locked.”

When the universal restraint system is deactivated, loop message: “Warning <optional 1 sec pause> Lock deactivated.”

When the universal restraint system is reactivated, play message: “Lock reactivated.”

When the electronic control unit does not see the proper solenoid connection voltage, loop message: “Solenoid malfunction <optional 1 sec pause> Service required.”

When the ignition is on and the release button is pressed, play message: “Please turn off ignition to unlock chair.”

When the ignition is off and the release button is pressed, play message: “Chair unlocked <optional 1 sec pause> Please roll back.”

Other messages of a similar nature can also be used, for the status conditions described above, or other conditions that may be of interest. Messages can be provided in a language of the user's choice, for better understandability. The volume of the audio messages can be adjusted, and in general it should be loud; and in particular should be sufficiently loud that users will not readily be able to ignore the safety warnings.

Following is an example of a state table for the vehicle ignition, restraint release switch, latching mechanism, and notification messages:

| Ignition | Remote | | | |
|---|---|---|---|---|
| Detection | Release | Latching | Message | |
| Sensor | Button | Mechanism | Number | Message |
| Transition | | Closed | 1 | Ready . . . Chair locked |
| to on | | | | |
| Transition | | Open | 2 | Stop . . . Chair not locked |
| to on | | | | |
| | | Deactivated | 3 | Warning . . . Lock deactivated |
| | | Transition from | 4 | Lock reactivated |
| | | deactivated to | | |
| | | activated | | |
| | | Low Voltage | 5 | Solenoid malfunction . . . Service |
| | | detected | | required |
| On | Pressed | | 6 | Please turn off ignition to |
| | Release | | | unlock chair |
| | Button | | | |
| Off | Pressed | Open | 7 | Chair unlocked . . . Please roll |
| | Release | | | back |
| | Button | | | |

It is preferred to include additional warning outputs, in addition to the voice messages described here, to provide a measure of redundancy. For example, LED indicators can be used, with red=stop, green=good/go, yellow=warning. A buzzer is still used to provide an initial prompt when there is a warning. For example, in one embodiment if a faulty solenoid is detected, or if an unlocked chair is detected, a three-beep warning signal precedes the voice message as otherwise described above. Lights, Buzzer/Beep & Voice. A combination of two or even all three of these outputs—lights, buzzer/beeper, and voice—provides redundancy and increases the likelihood that a user will not overlook a problem.

### Description of a Universal Restraint System

The present invention may be used with restraint docking systems generally. A preferred restraint system for use with the present invention is the universal restraint system for wheelchairs and other mobile carriers otherwise described in U.S. Pat. No. 6,685,403. See the U.S. Pat. No. 6,685,403 for further details; the entire disclosure of the U.S. Pat. No. 6,685,403 is incorporated by reference. A summary is provided below:

The mobile occupant carrier restraint device allows the occupant to perform self-securement in a vehicle, or another person can secure the mobile occupant carrier. The device is a universal, mobile occupant carrying restraint that may be used with almost any commercially-available mobile occupant carrier. The device comprises at least one mounted universal adaptor attached to the frame of an occupant carrier, a bracket assembly having a single horizontally-displaced latch interface, and a docking station assembly with a single latching mechanism. The universal adaptor(s) may be vertically mounted to the frame to provide vertical adjustment, to provide easy mounting and dismounting of the bracket assembly, and to provide resistance in collisions. The docking station assembly is mounted to the floor of a transport vehicle in a receiving position and receives the horizontal latch interface. Upon loading a mobile occupant carrier into the transport vehicle, the carrier is moved towards the docking station assembly to a position that allows the single horizontal latch interface to engage the single latching mechanism, thus securing the carrier. The single latch interface allows an occupant to secure a carrier with a greater amount of ease when compared to a dual latch interface because there is only one securing point instead of two. Additionally, the horizontal latch interface assists in resisting any horizontal movement that would be caused by a side impact. Moreover, the wide displacement of the latch interface has a greater resistance to horizontal bending as compared to a vertically displaced latch. The restraint system can also be used to secure other small-size wheeled carriers into a transport vehicle. The device not only secures small-size carriers during transportation, but also serves as a theft deterrent.

The restraint device provides for fast, self-securement of mobile occupant carriers, particularly wheelchair passengers in transport vehicles, by using a universal docking station and a bracket assembly that can be adjusted to fit almost any carrier frame. Because the interface between the wheelchair and the docking station is horizontally positioned, it is capable of resisting the forces that would be created by either a front or a side collision. The universal adaptor(s) that bolt to the wheelchair frame can optionally function as an anchor for tie-downs in vehicles without docking stations. The bracket assembly size can be adjusted to fit almost any wheelchair frame. The docking station height can also be adjusted to accommodate wheelchairs of various heights. The system can be adapted to secure other small-sized wheeled carriers during transport, including scooters, all-terrain vehicles, small tractors, riding lawn mowers, and a wide variety of other similar carriers.

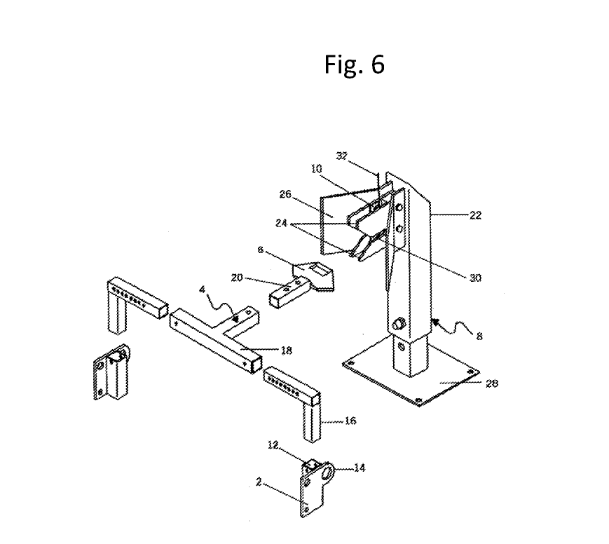

FIGS. 6, 7, and 8 illustrate one embodiment of such a device. As seen in FIGS. 6, 7, and 8, the restraint is shown securing a wheelchair in either a passenger, a mass transit, or a transport vehicle. The embodiment in FIG. 6 comprises a pair of universal adaptors 2, which also optionally function as tie-downs, a bracket assembly 4 with a latch interface 6, and a docking station assembly 8 with a latching mechanism 10 to receive the latch interface 6. In this embodiment, the universal adaptors 2 have vertical openings 12 and are mounted near the rear of the occupant carrier, either on a horizontal or a vertical frame member. The vertical openings 12 are sized to allow the L-bars 16 of the bracket assembly 4 to be snugly mounted in a quick fashion. In a preferred embodiment, the vertical openings 12 are non-circular to resist rotational movement. At the front end of each of the adaptors 2, there may optionally be an eye-ring 14 to secure the carrier by tie-downs, when not operated in conjunction with the docking assembly 8. For additional safety and restraint, a lap belt can be anchored to the universal adaptors 2.

As illustrated in FIG. 6, the bracket assembly 4 comprises a pair of adjustable L-bars 16, a T-bar 18, and an adjustable latch interface 6 horizontally displaced. The L-bars 16 are adapted to engage the adaptors 2 vertically while engaging the T-bar 18 horizontally. The distance between the L-bar 16 ends that slide into the adaptors 2 can be adjusted to fit the distance between the adaptors 2 on the wheelchair. In a preferred embodiment, the latch interface 6 is hexagonally shaped with a shaft 20 located on the opposite side of the latch device to attach to the T-bar 18. The angular sides of the latch interface 6 help guide it into the latch of the docking station assembly 8.

As illustrated in FIG. 6, the docking station assembly 8 comprises a docking stanchion 22, horizontal V-guides 24, vertical V-guides 26, a latch 10, and a base plate 28. The base plate 28 is secured (e.g., welded, or bolted if removal is necessary) to the floor of a vehicle in a receiving position. The docking stanchion 22 extends upward from the floor. The height of the docking stanchion 22 may be adjusted to accommodate the height of the latch interface 6. The vertical guides 26 guide the latch interface 6 and prevent horizontal movement of the bracket assembly 4 after latching. The horizontal guides 24 guide the latch interface 6 into a horizontal latching slot 30 and limit vertical movement. The width and length of the slot 30 assist in limiting vertical movement by forming a tight fit with the latch interface 6.

FIG. 6 illustrates an embodiment of the latching mechanism 10 containing a manual release lever 32 that allows the occupant to disengage the restraint device. FIG. 6 shows two universal adaptors 2, T-bar 18, and L-bars 16, preferably made of rectangular or square steel. These components could also be tubular steel. Latching mechanism 10 additionally includes a sensor and an electronic release mechanism (not shown), allowing a vehicle driver to remotely monitor a secure latching operation and to electronically release the latch to disengage the wheelchair, in conjunction with the voice notification circuit as previously described. Optionally, a single universal adaptor can be used to mount to the frame.

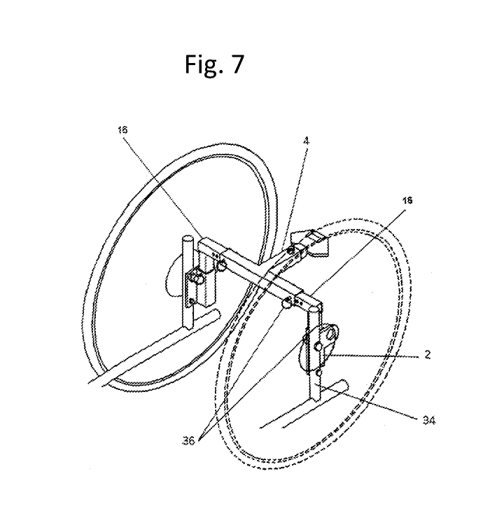

FIG. 7 illustrates a perspective view of one embodiment of the universal adaptors 2 attached to vertical members of a wheelchair frame 34 and engaged by the bracket assembly 4. The spacing between the adaptors 2 is determined by the wheelchair frame. The bracket assembly 4 is adjusted to fit this spacing by adjusting the length of L-bars 16, by aligning holes in the T-bar 18 to the holes in the L-bars 16, and securing with a cotter-pin or bolt 36.

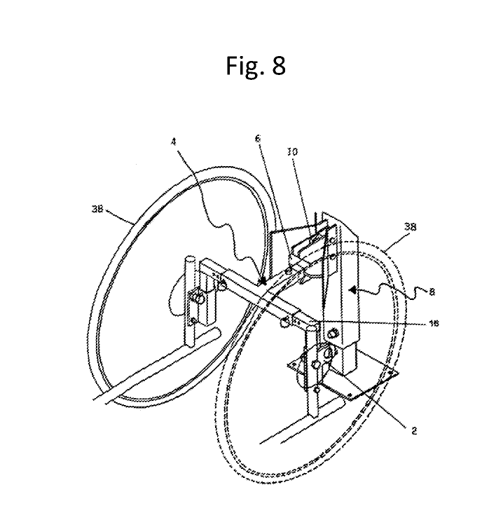

FIG. 8 illustrates a perspective view of one embodiment of the universal docking system with the latch interface 6 inside the latching mechanism 10. The bracket assembly 4 engages the universal adaptors 2 vertically by inserting the L-bars 16 into the vertical openings in the universal adaptors 2. Latch interface 6 is centrally located and extends along a horizontal plane to a position internal of the wheel base 38, allowing the wheelchair to be positioned in close proximity with the docking station assembly 8.

Features of the preferred docking system include: (1) the restraint system withstands side impacts well; (2) the bracket assembly 4 is easily attached to the universal adaptors 2, allowing the bracket assembly 4 to be detached from the mobile occupant carrier and kept in the transit vehicle; (3) the docking system guides the latch interface 6 into the latch 10, which simplifies backing a mobile occupant carrier into the latching assembly 10; (4) the bracket assembly 4 prevents a foldable wheelchair from folding when the vehicle is involved in a collision; (5) the universal adaptors 2 can be designed to be used as part of a four-point tie-down system; and (6) the universal adaptors 2 can serve as an anchor point for another latch design so long as the device fits snugly into the vertical openings 12.

The universal restraint system can also be used in securing a small-sized, wheeled carrier into a transport vehicle, e.g., a scooter or four-wheeler in the bed of a truck. An alternative embodiment would be the use of a single universal adapter mounted to the frame of the carrier. Additionally, the horizontal latch interface could be adapted to be directly mounted to the frame without the use of an additional adapter or bracket system. Advantages of the universal restraint system in transporting these small-sized carriers are that the carrier can be driven into the vehicle such that the horizontal latch interface is secured in the latching mechanism; that the height of the docking station can be adjusted to accommodate carriers of different heights; and that the docking station can be removed from the vehicle and stored when not in use.

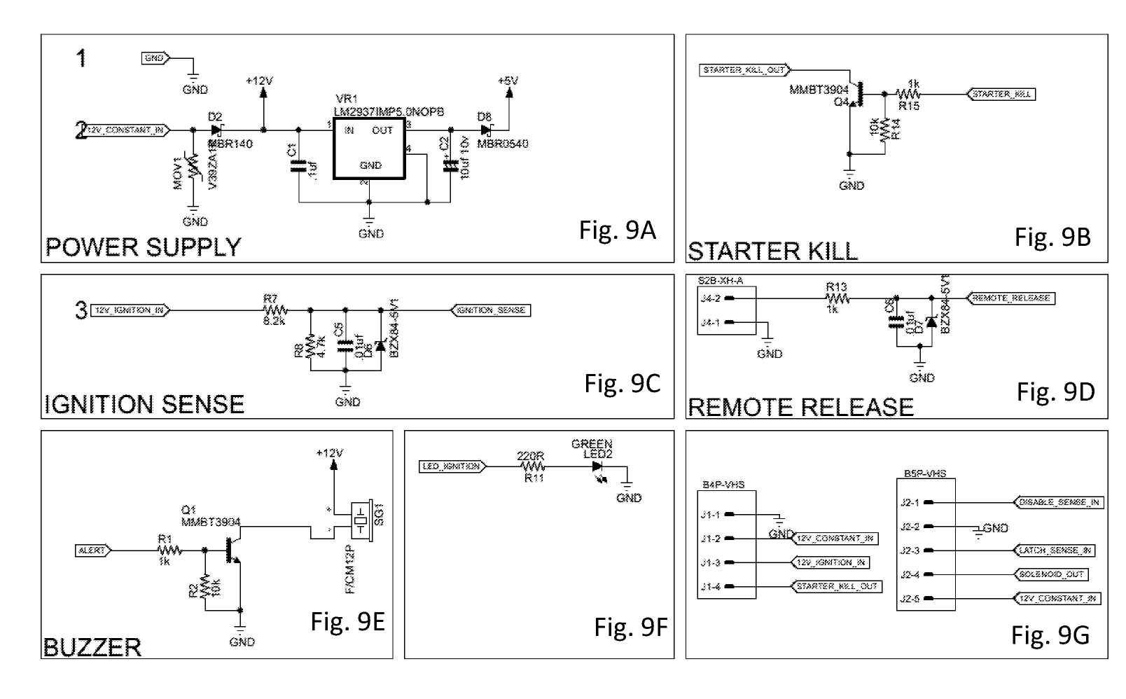

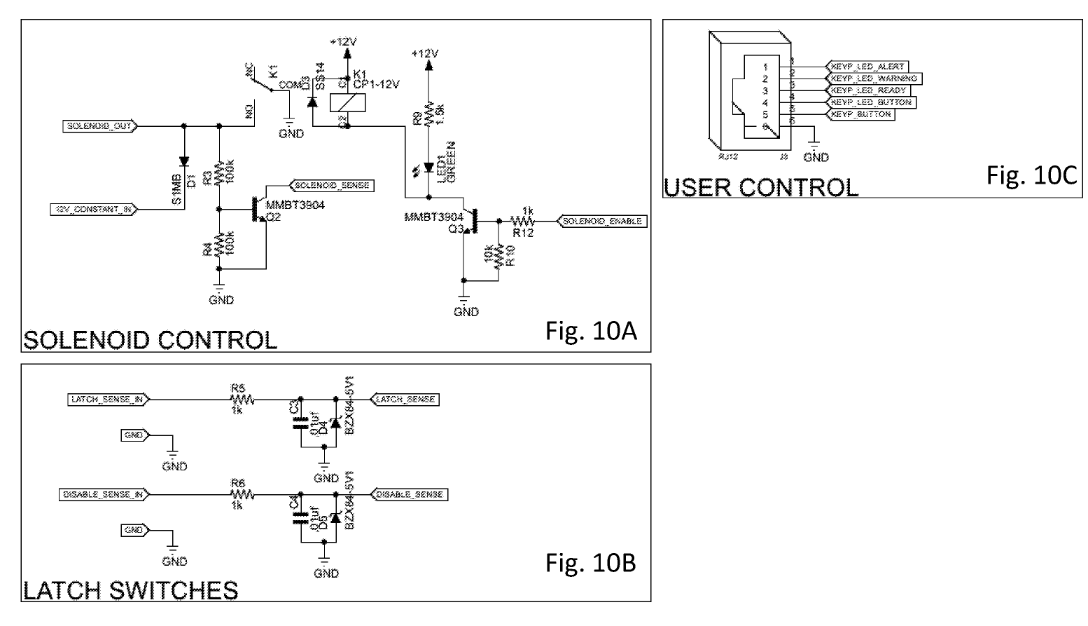

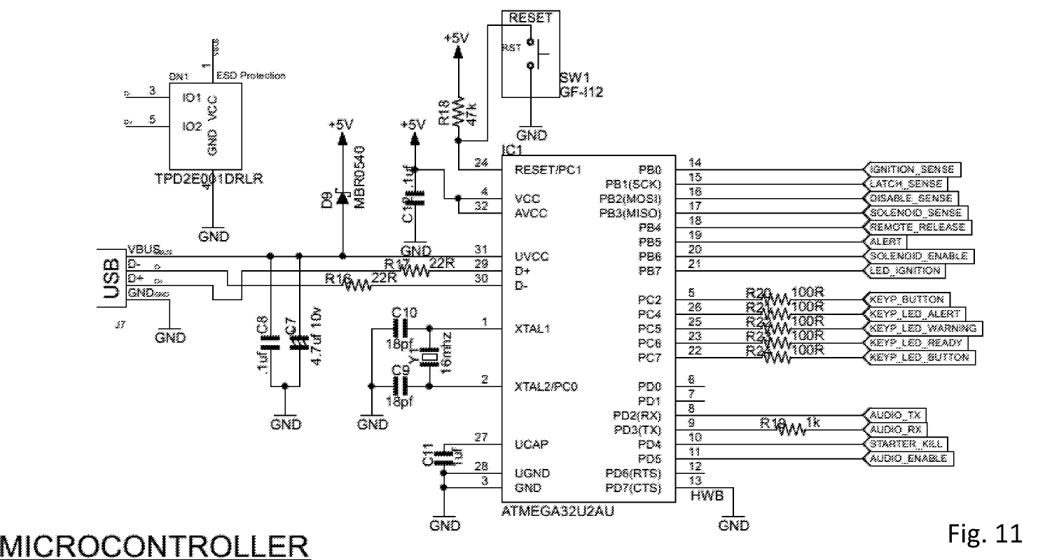

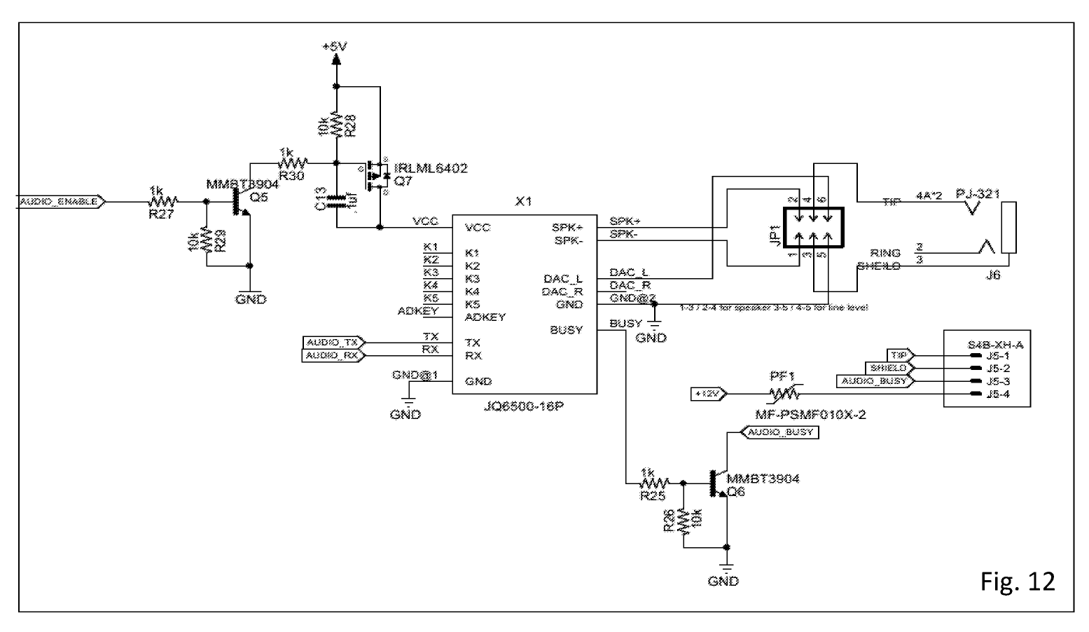

FIGS. 9A through 9G, 10A through 10C, 11, and 12 depict circuit elements used in one embodiment of the invention. The use of these particular circuit elements is entirely optionally, and they are depicted for convenience of reference only.

The complete disclosures of all references cited in this specification are hereby incorporated by reference in their entirety, as is the complete disclosure of priority application Ser. No. 62/461,797. In the event of an otherwise irresolvable conflict, however, the disclosure of the present specification shall control.

What is claimed:

1. A method for enhancing the safety of a passenger in a mobile occupant carrier, wherein the carrier is inside a motor vehicle; wherein the motor vehicle optionally has a driver; wherein the passenger and the driver may be the same or different individuals; and wherein the motor vehicle comprises an ignition system; said method comprising:
(a) securely and reversibly latching, or attempting to latch, the mobile occupant carrier to a docking base, wherein the docking base is rigidly attached to the motor vehicle; wherein the docking base comprises a latching mechanism capable of securely holding the mobile occupant carrier; wherein the latching mechanism is actuated and deactuated by a solenoid;
(b) detecting the status of the ignition system, detecting the status of the latching mechanism, and detecting the status of the solenoid;
(c) inputting the detected status of the ignition system, the detected status of the latching mechanism, and the detected status of the solenoid to a voice notification circuit;
(d) processing the detected status of the ignition system, the detected status of the latching mechanism, and the detected status of the solenoid by the voice notification circuit;
(e) outputting at least one audible, verbal signal by the voice notification circuit; wherein the audible signal comprises a voice message to alert the passenger, the driver, or both when the mobile occupant carrier is improperly secured to the latching mechanism, or when another potentially dangerous condition is detected; wherein the voice message also advises the passenger, the driver, or both, of an appropriate remedial action to be taken when the mobile occupant carrier is improperly secured to the latching mechanism or another potentially dangerous condition is detected; wherein the audible, verbal signal is in a language that is understood by the passenger, by the driver, or both; and wherein the volume of the audible, verbal signal is sufficiently loud that it cannot readily be ignored by the passenger, or the driver, or both; and
(f) if the voice notification circuit determines that the mobile occupant carrier is improperly secured to the latching mechanism, or if another potentially dangerous condition is detected, then repeating the audible, verbal signal until the mobile occupant carrier has been properly secured to the latching mechanism, or until the other potentially dangerous condition is no longer present.

2. The method of claim 1, wherein the voice notification circuit additional deactivates the vehicle's ignition system, or otherwise disables the vehicle, when the mobile occupant carrier is improperly secured to the latching mechanism or another potentially dangerous condition is detected.

3. The method of claim 1, wherein a warning audible verbal signal is output when one or more of the following conditions is detected: (a) when the vehicle's ignition system transitions from off to on, and the latching mechanism is open; (b) when the vehicle's ignition system is on, and the latching mechanism is open; (c) when the vehicle's ignition system is on, and the latching mechanism is opened; (d) when the vehicle's ignition system is on and there is an attempt to release the latching mechanism; or (e) when the measured solenoid voltage is outside an acceptable range.

4. The method of claim 1, wherein the mobile occupant carrier is an unmotorized wheelchair, a power base wheelchair, or a three-wheeled scooter.

5. The method of claim 1, additionally comprising the step of accompanying or preceding the audible, verbal signal with an auxiliary output; wherein the auxiliary output comprises one or more of: a buzzing sound, a beeping sound, or a colored light.
